(19) United States
(12) Patent Application Publication
(10) Pub. No.: US 2014/0333073 A1
(43) Pub. Date: Nov. 13, 2014

(54) TAMPER EVIDENT LOCK ASSEMBLY

(71) Applicants: Ian Bartos, Blackburn (AU); Harris Lambrou, Blackburn (AU)

(72) Inventors: Ian Bartos, Blackburn (AU); Harris Lambrou, Blackburn (AU)

(73) Assignee: Gainsborough Hardware Industries Limited, Blackburn, Victoria (AU)

(21) Appl. No.: 13/992,028

(22) PCT Filed: Jan. 19, 2012
(86) PCT No.: PCT/AU2012/000040

§ 371 Date: Jul. 12, 2013

(30) Foreign Application Priority Data
Jan. 21, 2011 (AU) 2011900195

(51) Int. Cl. E05B 59/00

(52) U.S. Cl. CPC E05B 59/00
USPC 292/32

(57) ABSTRACT

A tamper evident lock assembly (20) including a housing (22), an alterable means (76) and a sensor (49). The housing (22) is adapted for installation in or on a door. The alterable means (76) in or on the housing (22) is adapted for altering the function and/or attributes of the lock assembly (20). The sensor (49) is adapted to sense any modification of the lock assembly (20) sufficient to provide access to the alterable means (76).

### FIELD OF THE INVENTION

The present invention relates to a tamper evident lock assembly.

The invention has been developed for use with a mortice lock and will be described hereinafter with reference to this application. However, it will be appreciated that the invention is not limited to this particular use and is also suitable for use in other types of locks, including surface mounted locks.

### BACKGROUND OF THE INVENTION

Mortice locks utilise two hubs, each associated with a lever or other handle on each side of a door. They can be configured to provide any one only of four different pairs of functions when locked or unlocked. Configuring a lock in the desired one of the four function pairs is known as handing the locking mechanism and allows the lock installer to ensure that the pair of functions best matches the requirement of a particular door. The ability to hand a lock: saves the lock manufacturer from having to make stock and sell four different locks, one for each condition; saves a customer from having to know which lock to order for which door; and avoids an incorrectly handed lock from being delivered. These last two requirements can be particularly important when purchasing a large number of lock assemblies for installation in, for example, a multi-story building with many doors.

Mortice locks have the majority of their componentry contained within a housing that is installed within a recess in a door. The recess extends into the door from the free or non-hinged edge. A face plate is mounted to the housing along the door's free edge, through which protrude a latch bolt and commonly an auxiliary latch bolt. The bolts engage with a strike plate in a door jamb. The construction and operation of such mortice locks is well understood by persons skilled in the art.

Mortice locks are known which have components that may be adjusted or altered in order to set the handing of the lock to one of the four desired function pairs. Such handing components are adjusted before the lock housing is installed within the door recess and thus concealed. Accordingly, the housing must be removed from the door in order to alter the handing state.

However, patent publication WO 2009/082778 discloses a mortice lock in which the handing components are positioned on the outside or the inside of the face plate. An advantage of this arrangement is it allows the handing of the lock to be quickly and easily changed or corrected after installation by only removing the face plate and without the need to disassemble the lock assembly or remove the lock assembly from the door recess. However, a disadvantage of this arrangement is that it similarly enables the security of the door to be quickly and easily compromised. For example, a lock which is handed to require key ingress and free egress may be altered to free ingress and free egress, and thus allow unauthorised passage at a later time. Alternatively, a lock which is handed to require key ingress and free egress may be altered to free ingress and key egress, and thus create a safety risk in the event of a fire or other hazardous event.

Locks are also known in which removal of the face plate allows changes to be made to the lock's function, for example substitution of a key cylinder. A disadvantage of such locks is the changes are not always evident when the face plate is subsequently reinstalled.

### OBJECT OF THE INVENTION

It is the object of the present invention to overcome or at least ameliorate one or more of the above disadvantages.

### SUMMARY OF THE INVENTION

Accordingly, in a first aspect, the present invention provides a tamper evident lock assembly, the lock assembly including:

a housing adapted for installation in or on a door;

alterable means in or on the housing adapted for altering the function and/or attributes of the lock assembly; and

a sensor adapted to sense any modification of the lock assembly sufficient to provide access to the alterable means.

The sensor is preferably an electric switch.

In a second aspect, the present invention provides a tamper evident lock assembly, the lock assembly including:

a housing adapted for installation in or on a door;

alterable means in or on the housing adapted for altering the function and/or attributes of the lock assembly; and

a sensor adapted to sense any modification of the lock assembly altering the alterable means.

The sensor is preferably an electric switch.

In one form, the sensor senses a change in a signal from the alterable means caused by the modification. In another form, the sensor senses a change in a signal from a device associated with the alterable means caused by the modification.

In a third aspect, the present invention provides a tamper evident lock assembly, the lock assembly including:

a housing adapted for installation in or on a door;

alterable means in or on the housing adapted for altering the function and/or attributes of the lock assembly; and

a sensor adapted to sense any approach to, the lock assembly, when installed, for altering the alterable means.

The sensor is preferably a light beam sensor or a proximity sensor, most preferably positioned outwardly adjacent the alterable means.

The alterable means is preferably any movable part of the lock assembly. The alterable means is preferably electrically operable, such as a switch, or mechanically operable, such as a button, knob, screw, lever, toggle, linkage or cam.

The alterable means are preferably accessible without removing the installed lock from the door.

The lock assembly preferably includes a face plate releasably mountable to the housing and a sensor responsive to interference with the face plate, or a part associated with the face plate.

The part associated with the face plate preferably includes: a fastener for fastening the face plate to the housing; a sub face plate connectable to the face plate; or a patch, button or blanking plug mountable in an opening in the face plate. The fastener is preferably one or more of a screw, bolt, magnet, hook and loop material, adhesive tape, slide, catch or hook.

The interference with the face plate, or a part associated with the face plate, preferably includes:

mounting the face plate, or the part associated with the face plate, on the housing;

removing the face plate, or the part associated with the face plate, from the housing;

removing the face plate, or the part associated with the face plate, from the housing and remounting the face plate, or the part associated with the face plate, to the housing; or

remounting the face plate, or the part associated with the face plate, to the housing.

The sensor is preferably adapted to issue a signal, or cease issuing a signal, when:

the face plate, or the part associated with the face plate, is installed on the housing;

the face plate, or the part associated with the face plate, is mounted to the housing;

the face plate, or the part associated with the face plate, is not mounted to the housing; or

when the face plate, or the part associated with the face plate, is remounted to the housing after removal from the housing.

In one form, the housing is installed within a recess in the door. In another form, the housing is installed on an outer face of the door.

The sensor is preferably mechanical, photoelectric, inductive or any of a variety of sensor types.

In one form, the sensor directly senses the physical presence of the faceplate or the part associated with the face plate. In another form, the sensor indirectly senses the physical presence of the faceplate, or the part associated with the face plate, via an intermediate mechanism. The intermediate mechanism is preferably one or more linkages or a magnet, most preferably attached to the face plate.

The signal preferably triggers a remote alarm or other indication of the tampering. The remote alarm or indication is preferably momentary, only showing while the face plate or the part associated with the face plate is mounted/not mounted/remounted. Alternatively, remote alarm or indication is latching, remaining until an authorised reset.

In one form, the authorised reset is preferably a remote signal, more preferably given from a control centre or other such as: an RF signal, an emf signal, an electric signal that can be communicated: through the ether, through a wire forming part of an existing circuit to the lock assembly, through a purpose fitted wire specifically for resetting purposes.

In another form, the authorised reset is preferably a local signal, more preferably given from a person in close proximity to the lock such as: an RF signal; an emf signal; an infra red signal; a sound signal; an electric signal; an influence from a proximity fob or a mechanical key, all providing an authorised communication with the lock assembly to provide a reset influence to some mechanical or electrically responding item.

Preferably, any and all of the above signals, local or remote, may: either reset the lock assembly, and/or reset the alarm state, and/or allow remounting of the faceplate.

Alternatively, the signal does not trigger a remote alarm or other indication and preferably triggers an internal lock change, such as locking the lock assembly and/or some other local alarm or tamper indicator on or near the lock until an authorised reset.

Alternatively, the signal triggers a remote alarm or other remote indicator and/or an internal lock change, such as locking the lock assembly and/or a local alarm or tamper indicator on or near the lock until an authorised reset.

In a fourth aspect, the present invention provides a tamper evident lock assembly, the lock assembly including:

a housing adapted for installing in or on a door;

alterable means in or on the housing adapted for altering the function and/or attributes of the lock assembly; and

a lock assembly disabling mechanism adapted to prevent operation of the lock assembly in response to any modification of the lock assembly sufficient to provide access to the alterable means and/or in response to any altering of the alterable means.

The lock assembly preferably includes a face plate releasably mountable to the housing and the lock assembly disabling mechanism is adapted to allow authorised operation of the lock assembly in response to authorised mounting of the face plate and to prevent operation of the lock assembly in response to interference with the face plate, or a part associated with the face plate.

The interference with the face plate, or a part associated with the face plate, preferably includes:

mounting the face plate, or the part associated with the face plate, on the housing;

removing the face plate, or a part associated with the face plate;

removing the face plate, or a part associated with the face plate, from the housing and remounting the face plate, or a part associated with the face plate, to the housing; or

remounting the face plate, or a part associated with the face plate, to the housing.

The lock assembly disabling mechanism is adapted to continue to prevent operation of the lock assembly after unauthorised remounting of the face plate or the part associated with the face plate and/or prevents the faceplate from being remounted.

In one form, the housing is installed within a recess in the door. In another form, the housing is installed on an outer face of the door.

The lock assembly disabling mechanism preferably includes:

a bolt blocking means movable between a first position allowing authorised operation of a lock bolt and a second position preventing operation of the lock bolt; and

means biasing the bolt blocking means towards the second position,

wherein the authorised mounting of the face plate, or the part associated with the face plate, to the housing permits moving of the bolt blocking means to the first position and removing the face plate, or the part associated with the face plate, from the housing allows the biasing means to move the bolt blocking means to the second position.

Any combination of mechanical and electrical tamper sensing and signalling is possible within a single lock. For example, an electrical tamper signal can also be used to trigger a mechanical operation within the lock.

The part associated with the face plate preferably includes: a fastener for fastening the face plate to the housing; a sub face plate connectable to the face plate; or a patch, button or blanking plug mountable in an opening in the face plate. The fastener is preferably one or more of a screw, bolt, magnet, hook and loop material, adhesive tape, slide, catch or hook.

### BRIEF DESCRIPTION OF THE DRAWINGS

Preferred embodiments of the present invention will now be described, by way of examples only, with reference to the accompanying drawings in which:

FIG. 1 is a perspective view of a first embodiment of a lock assembly;

FIG. 2 is a perspective view of the lock assembly shown in FIG. 1 with the face plate removed;

FIG. 3 is a perspective view of the lock assembly shown in FIG. 2 with a side cover also removed;

FIG. 4 is a perspective view of a second embodiment of a lock assembly;

FIG. 5 is a side perspective view of a third embodiment of a lock assembly;

FIG. 6 is a perspective view of a fourth embodiment of a lock assembly;

FIG. 7 is a side perspective view of the lock assembly shown in FIG. 6 with a side cover removed;

FIG. 8 is a partial cutaway perspective view of the lock assembly shown in FIG. 7;

FIG. 9 is a partial enlarged perspective view of the lock assembly shown in FIG. 8;

FIG. 10 is a perspective view of the lock assembly shown in FIG. 8 with bolts retracted;

FIG. 11 is a perspective view of the lock shown in FIG. 8 with a face plate removed;

FIG. 12 is a partial enlarged perspective view of the lock assembly shown in FIG. 11;

FIG. 13 is a side perspective view of the lock assembly shown in FIG. 11 with a disabling mechanism being reset;

FIG. 14 is a perspective view of a fifth embodiment of a lock assembly;

FIG. 15 is a schematic wiring diagram for the lock assembly shown in FIG. 14;

FIG. 16a is a perspective view of a sixth embodiment of a lock assembly;

FIG. 16b is an enlarged detailed view of the lock assembly shown in FIG. 16a;

FIG. 17 shows the lock assembly of FIG. 16a after tampering;

FIG. 18 is a schematic wiring diagram for the lock assembly shown in FIG. 16a;

FIG. 19 is a perspective view of a seventh embodiment of a lock assembly; and

FIG. 20 is a schematic wiring diagram for the lock assembly shown in FIG. 19.

### DETAILED DESCRIPTION OF THE PREFERRED EMBODIMENTS

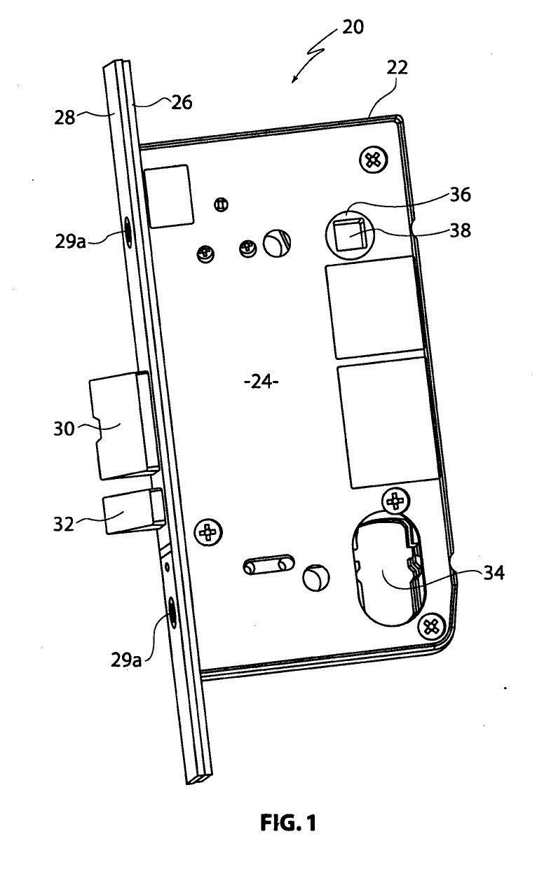

FIG. 1 shows a first embodiment of an electrically controlled, tamper evident lock assembly 20. The lock assembly 20 includes a housing 22 with a side cover 24. The lock assembly 20 also includes a (housing side) mounting plate 26 and a (door edge side) face plate 28.

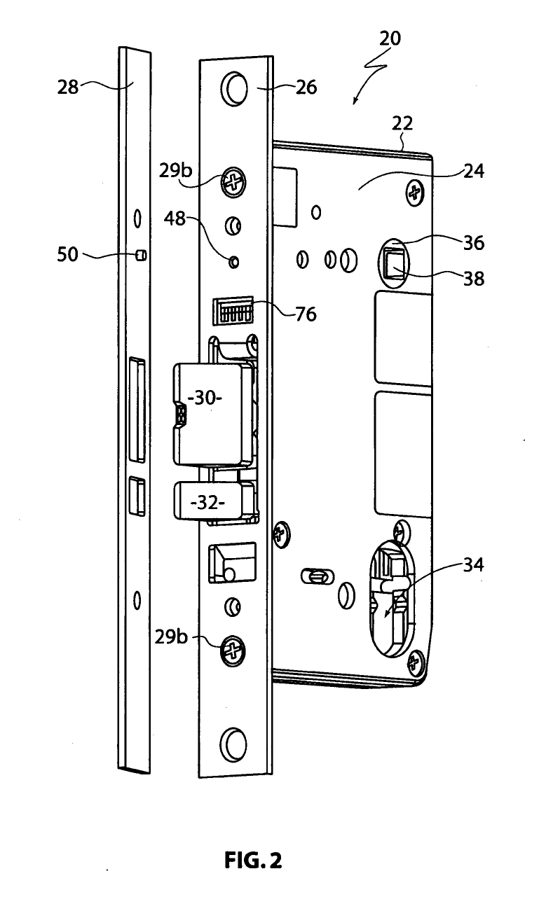

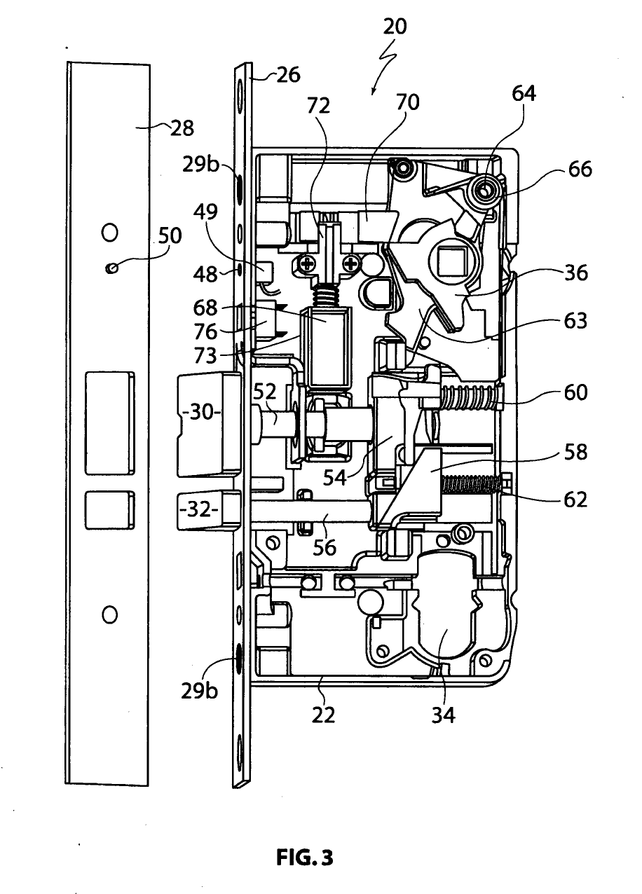

The face plate 28 is mounted to the housing 22 by face plate fasteners, in the form of screws 29a. The mounting plate 26 is similarly mounted to the housing 22 by screws 29b (see FIGS. 2 and 3).

The lock assembly 20 is installed in a door with the face plate 28 adjacent to the non-hinged edge of the door. A latch bolt 30 and an auxiliary latch bolt 32 pass through the mounting plate 26 and the face plate 28 for engagement with a strike plate (not shown) in a door jamb.

The lock assembly 20 also includes an opening 34 that receives a key cylinder (not shown). The key cylinder is retained within the opening 34 with a key cylinder retaining pin (not shown). After the key cylinder has been inserted into the opening 34, and the key cylinder retaining pin inserted into the key cylinder, the key cylinder retaining pin is prevented from releasing its engagement with the key cylinder by engagement of the face plate 28 with the housing 22.

The lock assembly 20 also includes a first hub 36 with a square cross-section opening 38 therein, which is adapted to engage with a square cross-section drive shaft (not shown) of a first external knob lever or other handle (not shown). A similar second hub is also provided on the opposite side of the lock assembly 20.

The construction and operation of the above described components are all well understood by persons skilled in the art

FIG. 2 shows the lock assembly 20 with the face plate 28 being interfered with, by virtue of it being removed. The removal of the face plate 28 provides access to alterable means, in the form of dip switches 76, which can be used to set a number of functions or attributes within the lock assembly 20, for example the disabling of one or both of the solenoids 68,73 shown in FIG. 3 or the monitoring the status of one or both sides of the lock assembly 20. Also exposed is a sensing tip 48, which communicates with a sensor, in the form of switch 49 (see FIG. 3). The face plate 28 includes a pin 50.

As best shown in FIG. 3, the latch bolt 30 is connected to a latch bolt shaft 52 which is in turn connected to a latch bolt carriage 54. The auxiliary bolt 32 is connected to an auxiliary bolt shaft 56 which is in turn connected to an auxiliary bolt carriage 58. The latch bolt 30 and the auxiliary bolt 32 are biased towards the latching position shown in FIG. 3 by a latch spring 60 and an auxiliary latch spring 62 respectively. A carriage retraction arm 63 is pivotally mounted to the housing 22 at shaft 64 and biased towards the latching position shown in FIG. 3 by a spring 66. The arm 63 can be moved, under certain conditions, to a non latching or door opening position retracting the latch bolt 30 and the auxiliary bolt 32, in response to movement of the first or second handles or the key cylinder, as will be well understood by persons skilled in the art.

FIG. 3 also shows an electrically controlled and powered first solenoid 68 which is controlled to move a first hub locker 70 via a first motion transfer mechanism 72 to selectively prevent or allow rotation of the first hub 36 in response to turning of the handle associated with the first hub 36. A second solenoid 73 similarly interacts with the second hub via a second motion transfer mechanism and a second hub locker.

When the face plate 28 is mounted to the housing 22 of the lock assembly 20, the pin 50 depresses the sensing tip 48 which results in a signal being issued by the switch 49 indicative of the face plate 28 being mounted to the housing 22. When the face plate 28 is removed, the pin 50 no longer depresses the tip 48 resulting in the switch 49 issuing a another signal indicating that the face plate 28 has been removed and that the settings of dip switches 76 may have been altered without authorisation.

The switch 49 can issue a first signal indicative of the tip 48 being depressed and a second, different, signal indicative of the tip 48 not being depressed. Alternatively, the switch 49 can issue a signal indicative of the tip 48 being depressed and the absence of a signal can indicate that the tip 48 is not being depressed. Further alternatively, the absence of a signal can be indicative of the tip 48 being depressed and a signal can be issued to indicate that the tip 48 is not being depressed.

The signal or signals can be communicated to a remote alarm or other indicator of the tampering. The remote alarm or indication is momentary, only showing while the face plate 28 is removed. Alternatively, the remote alarm or indication is latching, and remains until an authorised reset. Further alternatively, the signal or signals do not trigger a remote alarm or other indication and instead triggers an internal change in the lock assembly 20, such as locking the lock assembly 20 until an authorised reset.

Accordingly, and advantageously, any unauthorised tampering of the lock assembly settings, or attempts to do so, can immediately be brought to the attention of a building's owner or security or any other relevant personnel. Alternatively and/or additionally, the signal or signals can trigger a tamper indicator on the lock assembly itself or door, such as a light, buzzer or a siren.

Further, any unauthorised tampering of any other aspect of the lock assembly's functions, or attempts to do so, can similarly immediately be brought to attention to a building's owner or security or any other relevant personnel and/or trigger a tamper indicator on the lock assembly itself or door.

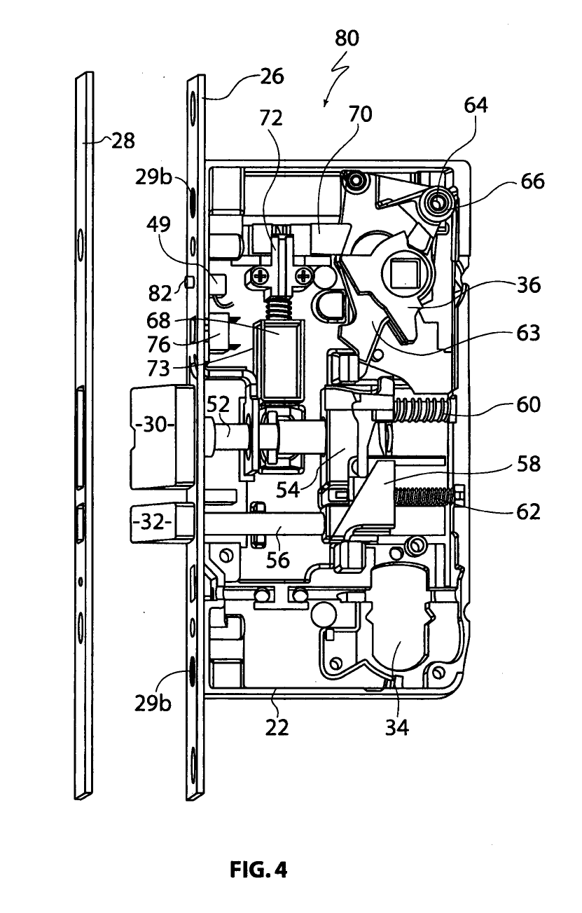

FIG. 4 shows a second embodiment of tamper evident lock assembly 80. The lock assembly 80 is similar to the lock assembly 20 and like features are indicated with like reference numerals. However, in the lock assembly 80, the sensing tip 82 protrudes through the mounting plate 26. The tip 82 is compressed towards the housing 22 to trigger the switch 49 by the installation of the face plate 28, thereby obviating the need for the pin 50 that was shown in FIG. 2.

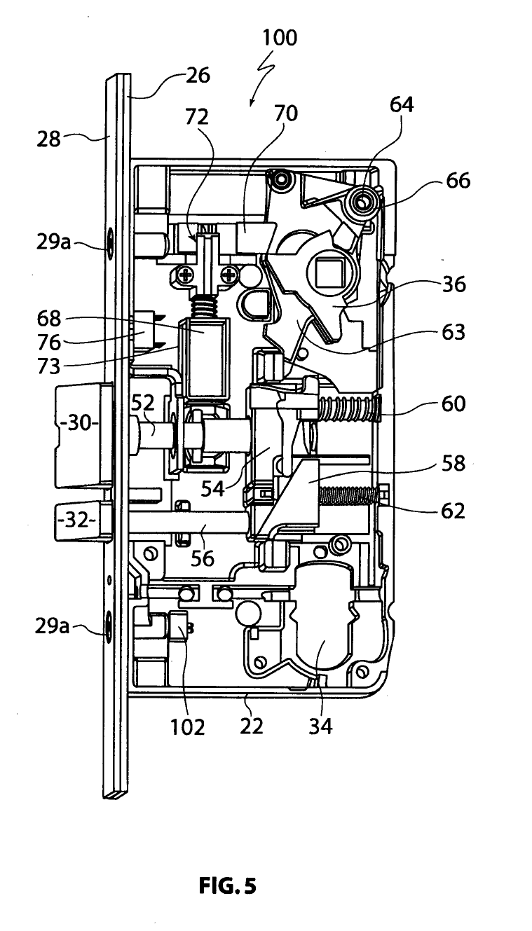

FIG. 5 shows a third embodiment of tamper evident lock assembly 100. The lock assembly 100 is similar to the lock assemblies 20 and 80 and like reference numerals will be used to note like features. However, the lock assembly 100 includes a switch 102 which monitors the presence (or lack of presence) of the lower face plate mounting screw 29a. Interference, such as the complete or partial removal of the screw 29a is again indicative of unauthorised removal or attempted unauthorised removal of the face plate 28.

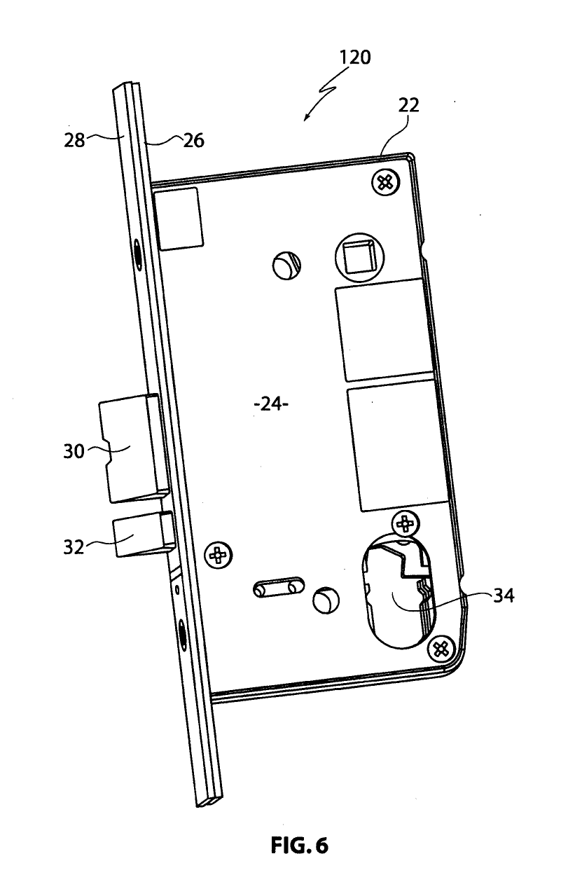

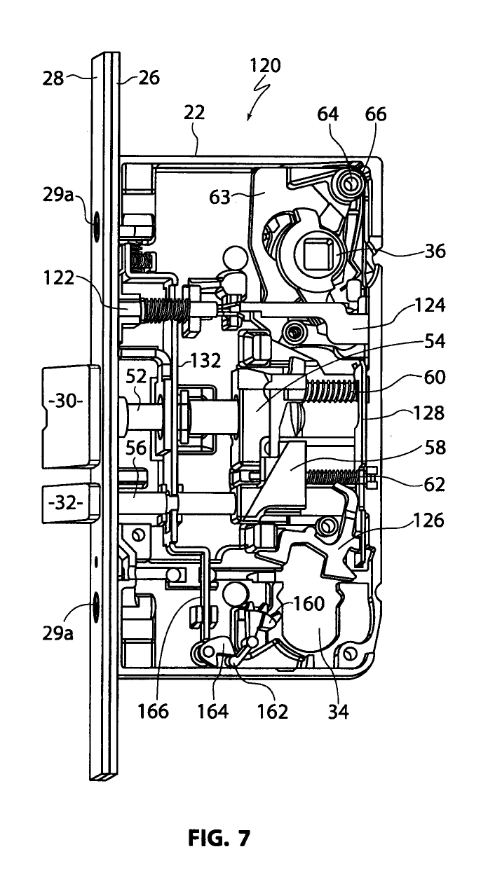

FIGS. 6 to 13 show a fourth embodiment of mechanically controlled lock assembly 120. The lock assembly 120 is somewhat similar to the lock assemblies 20, 80 and 100 and like features are indicated with like reference numerals.

The lock assembly 120 includes an alterable means, in the form of a first handing pin 122, which is accessible when the face plate 28 is removed and which is operable on a first hub handing bar 124 to enable the first hub 36 to be configured as locked or free egress. A second handing pin (not shown) is similarly operable on a second hub handing bar to enable the second hub to be independently configured as locked or free egress. Once the first and/or second hub are selected to offer a locked function pair, the door is then locked and unlocked by a correct key in the key cylinder driving a rocker 126 to alter the position of a locking bar 128. Such mechanisms are well understood by persons skilled in the art.

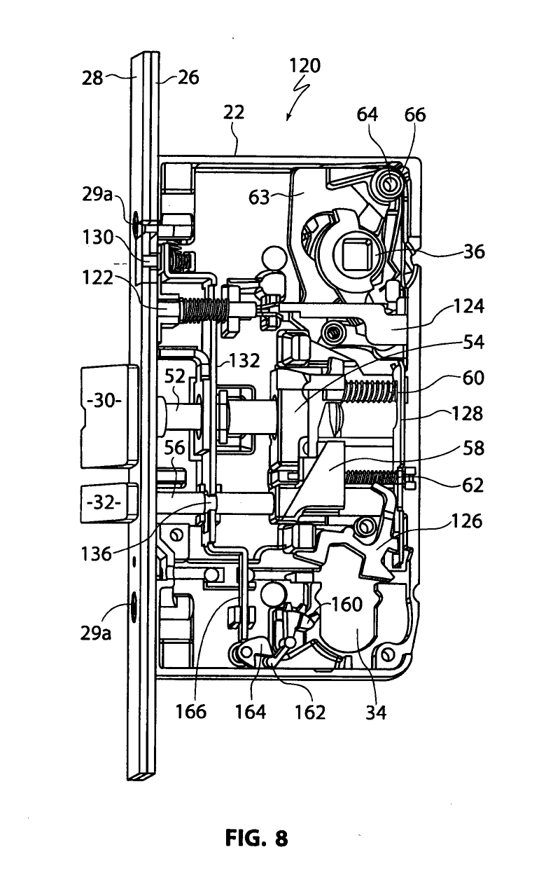

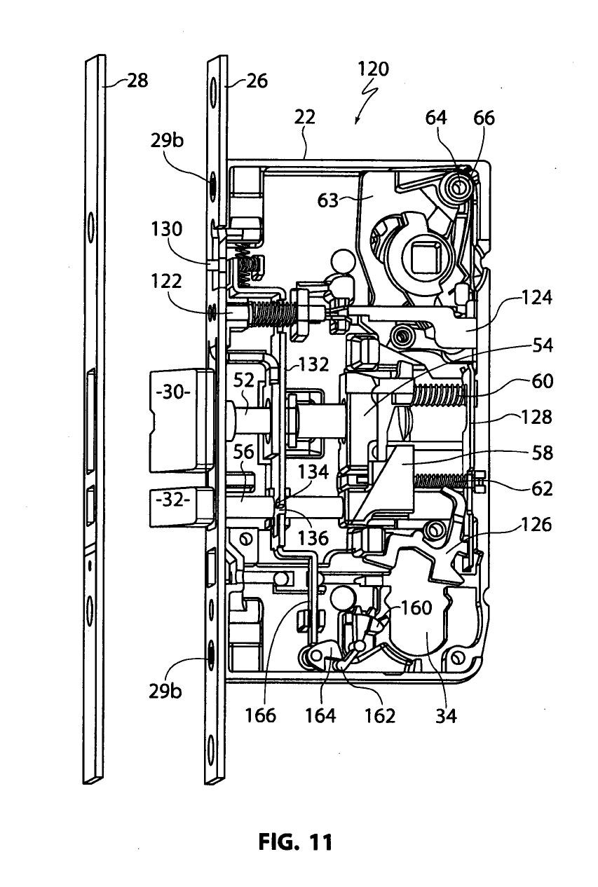

FIG. 8 shows a lock assembly disabling mechanism including a sensing pin 130 associated with a bolt locking bar 132. The bolt locking bar 132 has a slotted opening 134 and the auxiliary latch bolt shaft 56 has a corresponding narrowed region 136. When the bolt locking bar 132 is in the position shown in FIG. 8, the auxiliary latch bolt shaft 56 can pass through the recess 134 thereby permitting the auxiliary latch bolt 32 to be retracted. When the bolt locking bar 132 is in the position shown in FIG. 11, the bolt locking bar 132 prevents movement of the auxiliary latch bolt shaft 56 and thus prevents retraction of the auxiliary latch bolt 32, as will be described in more detail below.

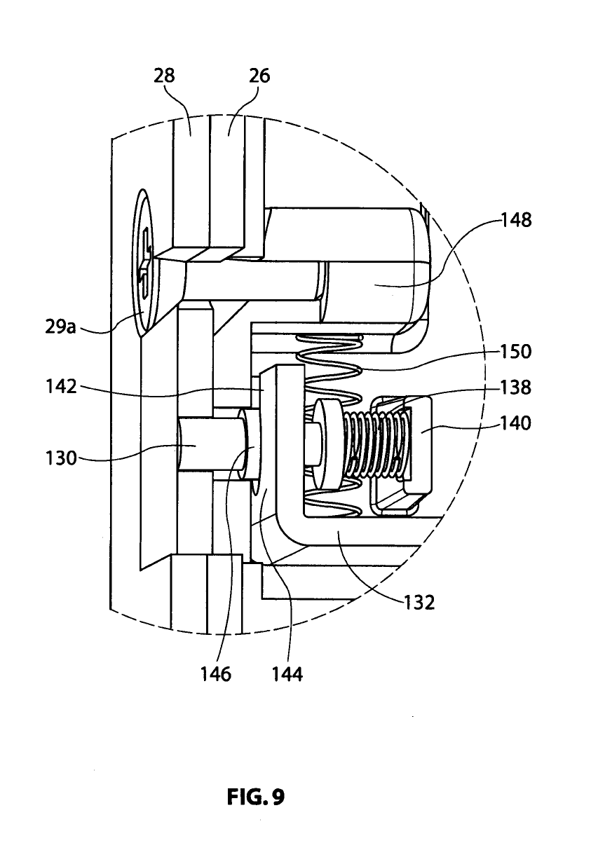

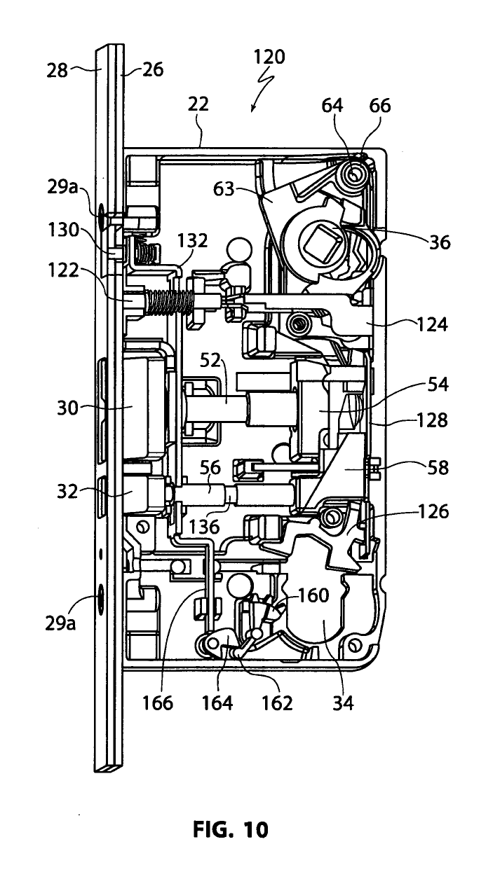

FIG. 9 shows the sensing pin 130 being biased towards the face plate 28 by a spring 138 acting against a stop 140. The adjacent end of the bolt locking bar 132 contains a slot having a narrower part 142 and a wider part 144. The wider slot part 144 engages with a collar 146 on the sensing pin 130. This engagement prevents the bolt locking bar 132 from being driven away from a stop 148 by a spring 150. As a result, the latch bolt 30 and the auxiliary latch bolt 32 may be retracted, as shown in FIG. 10, by the carriage retraction arm 63 being moved by rotation of one of the first or second hub.

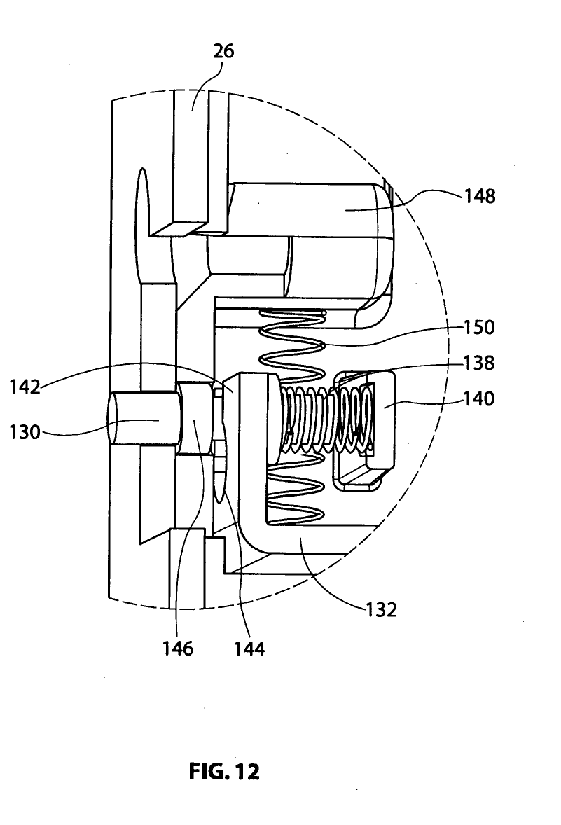

FIG. 11 shows the lock assembly 120 after removal of the face plate 28. As best seen in FIG. 12, the removal of the face plate 28 allows the sensing pin 130 to be driven outwardly by the spring 138 until the collar 146 is no longer engaged with the wider slot part 144. As a result, the movement of the locking bar 132 is no longer prevented and the spring 150 is able to drive the hub locking bar 132 away from the stop 148 to the position shown in FIG. 11. In this position, the recess 134 in the bolt locking bar 132 engages with the narrowed region 136 of the auxiliary latch bolt shaft 56, thereafter preventing movement of the auxiliary bolt shaft 56 and thus the auxiliary latch bolt 32. The auxiliary bolt carriage 58 is also prevented from retracting as it is connected to the auxiliary bolt shaft 56. As the auxiliary bolt carriage 58 overlaps the latch bolt carriage 54, the latch bolt carriage 54, the latch bolt shaft 52 and the latch bolt 30 are also prevented from retracting. As the auxiliary latch bolt 32 and the latchbolt 30 are prevented from moving, the door housing the lock assembly 120 can no longer be latched closed making it clear to subsequent users that the lock assembly 120 has been tampered with. In addition, the faceplate 28 can not be remounted to the housing 22 at this point as the sensing pin 130 is sitting outwardly of the front face of the mounting plate 26. As a result, the faceplate 28 can not sit flush on the mounting plate 26 and can not be fully fastened. The faceplate 28 can not push the sensing pin 130 into the housing 22 as the collar 146 of the sensing pin 130 is opposite the narrower part 142 of the slot in locking bar 132.

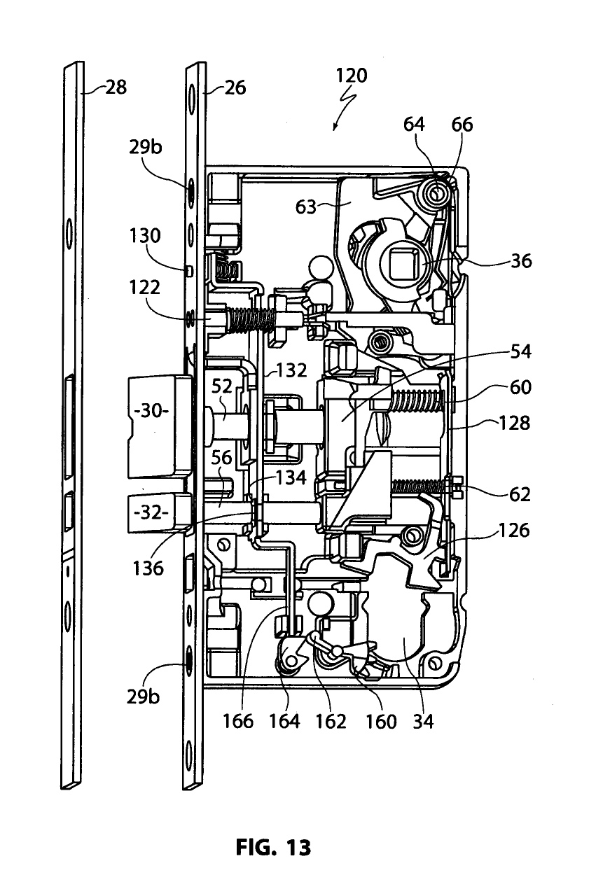

An authorised resetting of the locking bar 132 will now be described with reference to FIG. 13. The correct key is used to drive a cam (not shown) of the key cylinder to cause a geared part 160 to rotate in a clockwise direction. This causes an eccentric part 162 associated with the geared part 160 to rotate a cam 164 in an anticlockwise direction. This movement of the cam 164 drives a reset push 166 which in turn drives the bolt locking bar 132 to the ‘reset’ position shown in FIG. 8. In this position, the auxiliary bolt shaft 56 is free to move through the recess 134 to enable bolt retraction. Also, this movement of the bolt locking bar positions the wider slot part 144 adjacent to the shoulder 146 of the sensing pin 130. Refitting of the face plate 28 at this time repositions the sensing pin 130 with the shoulder 146 engaged with the wider slot part 144, as shown in FIG. 9. The correct key is then rotated in the key cylinder to drive the geared part 160 in an anticlockwise direction so as to cause the cam 164 to be driven in a clockwise direction back to the position shown in FIG. 13. Accordingly, this resetting operation can only be achieved by an authorised user having a correct key and is thus secure. The authourised resetting operation described above also permits the faceplate 28 to be remounted to the housing 22 as it involves retracting the sensing pin 130 into the housing 22 as shown in FIG. 8.

As with the electrical controllable lock assemblies, any interference or tampering (e.g. of the handing states), or attempts to do so, of the mechanical lock assembly result in the lock assembly being disabled in such a manner as to draw attention to the tampering. In addition, an electrical sensor or switch can be triggered by movement of the bolt locking bar or the sensing pin to provide other remote or local indications of tampering being performed or attempted.

Further, any unauthorised tampering of any other aspect of the lock assembly's functions, or attempts to do so, can similarly immediately be brought to attention to a building's owner or security or any other relevant personnel and/or trigger a tamper indicator on the lock assembly itself or door.

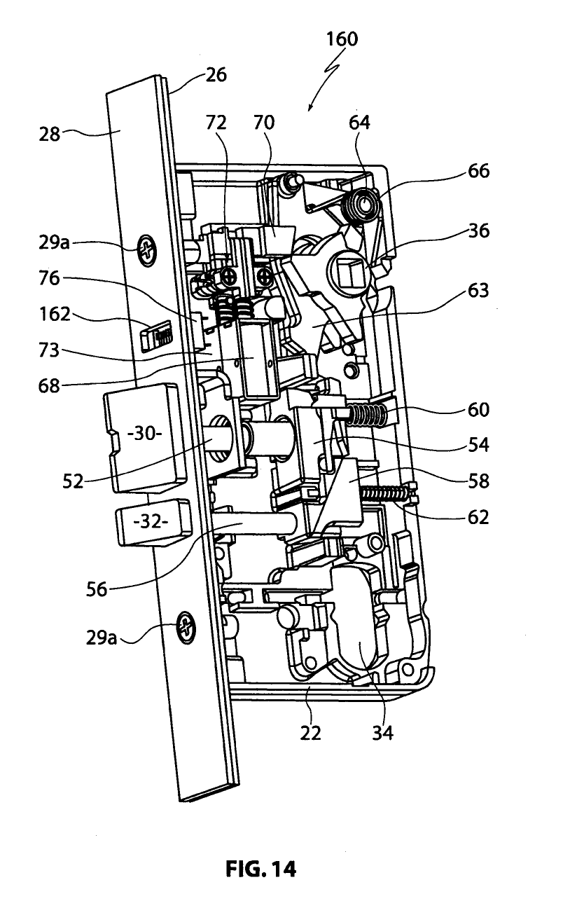

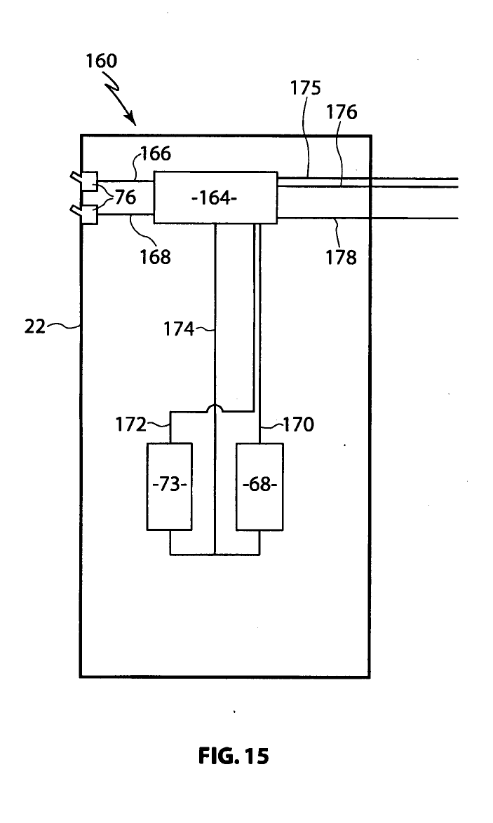

FIGS. 14 and 15 show a fifth embodiment of a lock assembly 160. The lock assembly 160 is similar to the lock assembly 100 and like features are indicated with like reference numerals. However, in the lock assembly 160, the face plate 28 includes an opening 162 which provides physical access to the dip switches 76 which are used to set a number of functions within the lock assembly 160. It will be appreciated that physical access to the dip switches 76 is always available. As any changes in the settings of the dip switches 76 will be indicated in some form, then no covering faceplate is needed to prevent access to the attribute adjustments.

FIG. 15 schematically shows the wiring associated with the dip switches 76, the first and second solenoids 68 and 73 and a controller 164. The controller 164 is connected to the dip switches 76 by wires 166 and 168. The controller 164 is connected to the solenoids 68 and 73 by power wires 170 and 172 and return wire 174. The controller 164 is also connected to control wires 175 and 176, for the two solenoids 68 and 73 respectively, within the wiring loom of a remotely located control system (not shown). The controller 164 is also connected to a sensing or attribute setting wire 178 within the wiring loom of the control system. This arrangement allows monitoring software in the control system to check for changes made to the dip switches 76 and react accordingly to any unauthorised changes detected. In addition, the controller 164 can sense unauthorised changes in the dip switches 76 and produce an internal change in the lock assembly 160, for example removing remote control from one or both of the solenoids 68 and 73.

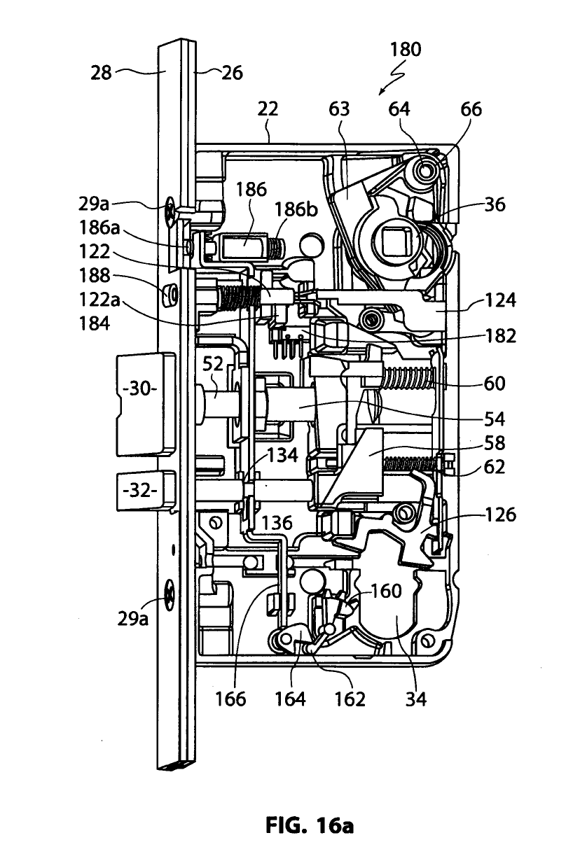

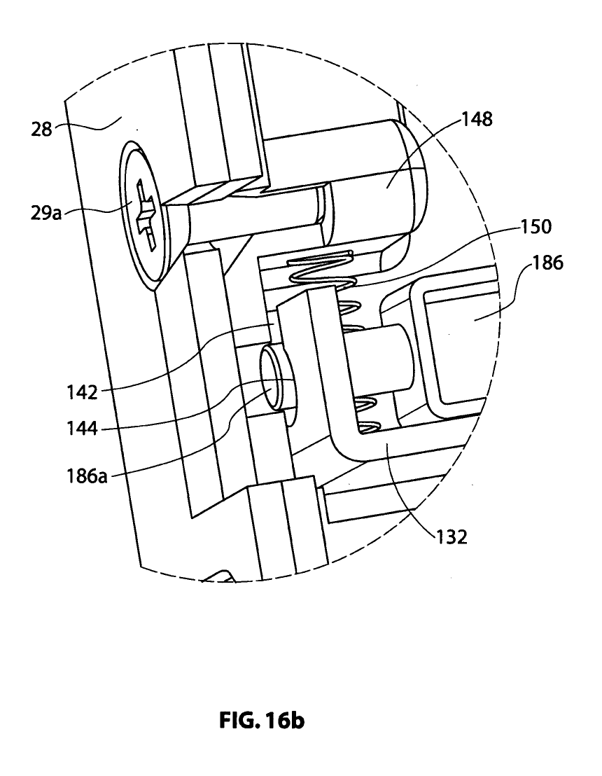

FIGS. 16a to 18 show a sixth embodiment of a lock assembly 180. The lock assembly 180 is similar to the lock assembly 120 and like features are indicated with like reference numerals. However, in the lock assembly 180, a switch 182 has been added to sense movement of the first handing pin 122. A tab 122a has also been added to the first handing pin 122 to act on the switches 182. A switch 184 has also been added to similarly sense movement of the second handing pin (not shown) associated with the opposite side of the lock assembly 180. These handing pins can be adjusted at any time as an opening 188 has been added to faceplate 28. Indeed no covering faceplate is needed to prevent access to the handing pins at all as was the case described in FIGS. 14-15.

The sensing pin 130 has also been replaced by a tamper solenoid 186 with a solenoid plunger 186a and plunger spring 186b. The solenoid 186 is a push type and is shown in FIG. 16a energised with the plunger 186a extended and the plunger spring 186b compressed. The plunger 186A is shown passing through the slot wider part 144 in the locking bar 132 and so holding the bolt locking bar 132 in the position shown which allows authorised functioning of the lock assembly 180.

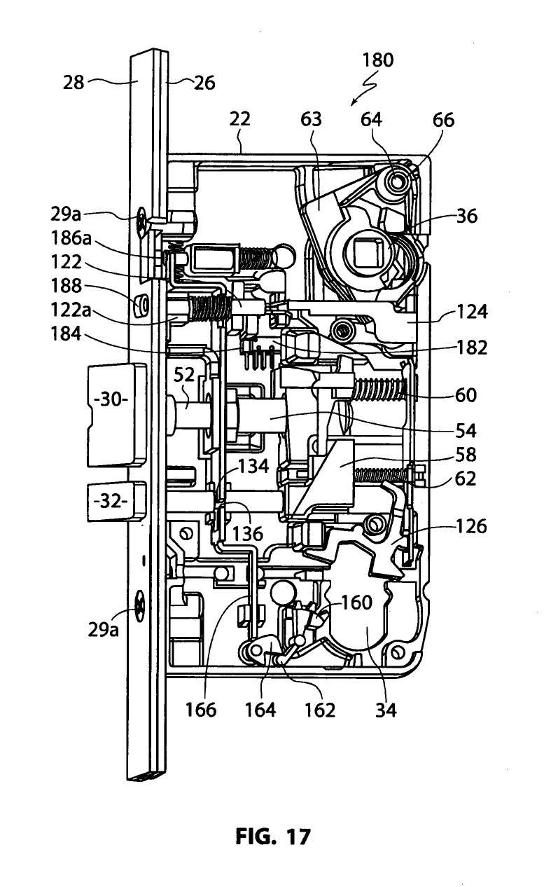

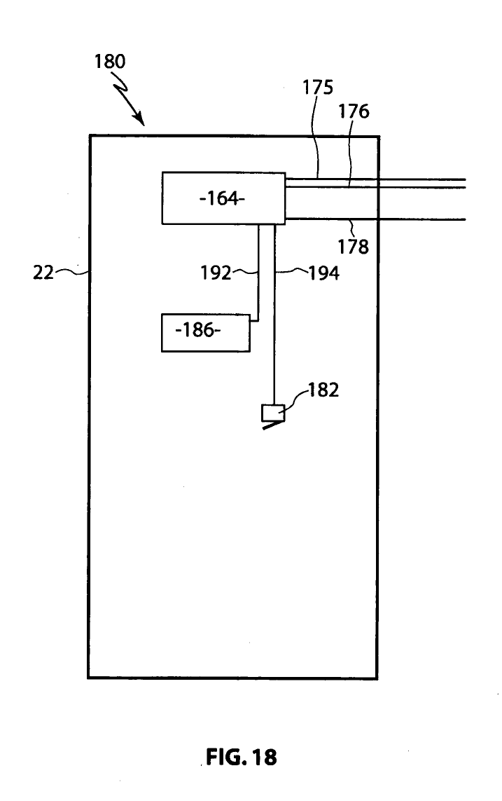

FIG. 17 shows the lock assembly 180 after the first handing pin 122 has been pushed inwardly which causes the tab 122a to act on the switch 182. This causes the switch 182 to either send a signal (or stop sending a signal) to the controller 164 (see FIG. 18). The controller 164 then switches off power to the tamper solenoid 186. As a result, the solenoid spring 186b moves the plunger 186a out of engagement with the slot wider part 144 which allows the bolt locking bar 132 to move to a position similar to that shown in FIG. 11. In this position, the bolt locking bar 132 locks the bolts 30 and 32 in a similar manner as to what was described in relation to FIG. 11. Simultaneously, the controller 164 sends a signal to a remotely located control system, alerting of the change and starting an alarm and other tamper indicator. The lock assembly 180 can later be reset in an authorised way by re-application of power to the tamper solenoid 186 and repositioning of the bolt locking bar 132 with the key, in a similar manner as to what was described in relation to FIG. 13.

FIG. 18 shows the wiring associated with the lock assembly 180. The controller 164 is connected to the tamper solenoid 186 by a power wire 192. The controller 164 is connected to the switch 182 by a sensor wire 194. As with the wiring discussed in relation to FIG. 15, the controller 164 is also connected to the control wires 175 and 176 and to a sensing or attribute setting wire 178 within the wiring loom of the control system. The controller 164 can communicate with the control system that has monitoring software that can check for setting changes in the lock assembly 180 and react accordingly to unauthorised changes (i.e. tampering). The controller 164 can also sense unauthorised changes in an attribute setting in the lock assembly 180 and produce an internal lock change, for example locking the bolts 30 and 32, in response to same.

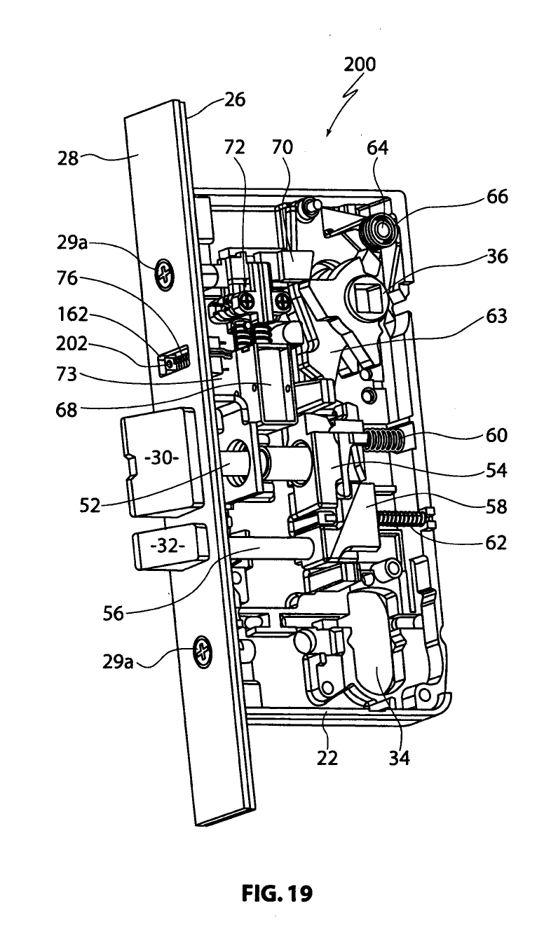

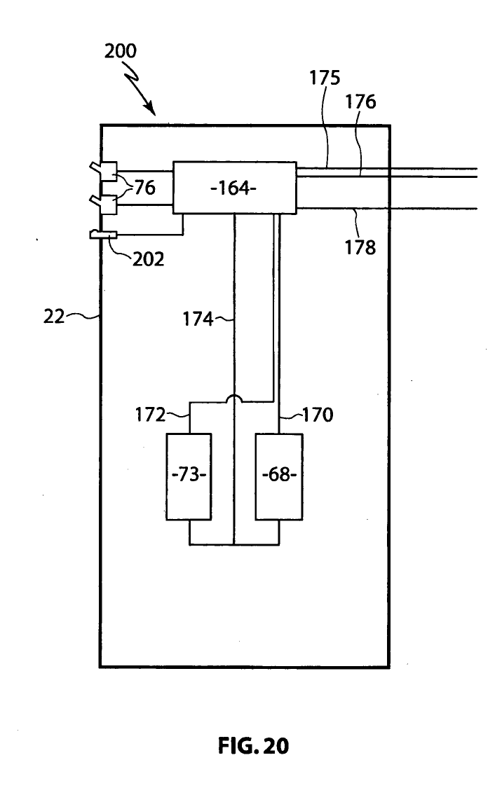

FIGS. 19 and 20 show a seventh embodiment of a lock assembly 200. The lock assembly 200 is similar to the lock assembly 160 and like reference numerals have been used to indicate like features. The lock assembly 200 includes a light beam or proximity sensor 202 just inboard of the opening 162 in the face plate 28. As with the lock assemblies described in FIGS. 14 to 18, no faceplate or other covering item preventing access to the attribute adjusters is needed as any changes will be indicated in some form.

As a result, if a potentially tampering approach is made to the dip switches 76 such as placing a screw driver through the opening 162, it will trigger the sensor 202. The sensor 202 can also be triggered by the presence of a magnetic flux near the dip switches 76 or the presence of a proximity fob near the dipswitch 76. Such approaches will be sensed by the sensor 202 and cause a signal to issue (or cease to issue) to the controller 164 that tampering has been attempted. The controller 164 can then disable the lock assembly 200 or generate remote signals similar to those as discussed with reference to FIGS. 14 to 15.

The embodiments of lock assemblies described above find particular application with, but are not limited to, the lock assembly disclosed in Australian provisional patent application No. 2011900194 filed on 21 Jan. 2011 by the Applicant and corresponding International PCT patent application. Those applications disclose a lock assembly in which switches able to alter a lock assembly's function or attributes are positioned substantially adjacent the door edge side of the housing, concealed under the face plate. This advantageously allows easy and quick changing or correction of desired settings in the lock assembly without having to remove the housing from within its recess in the door.

The positioning of the switches in this way could make them susceptible to unauthourised tampering. However, use of the embodiments of lock assemblies described above allows such unauthorised tampering of the settings, or attempts to do so, to immediately be brought to the attention of a building's owner or security or any other relevant personnel. Alternatively and/or additionally, the signal or signals can trigger a tamper indicator on the lock assembly itself or door, such as a light, buzzer or a siren.

Although the invention has been described with reference to preferred embodiments, it will be appreciated by persons skilled in the art that the invention can be embodied in many other forms. As an example, the screw face plate fasteners can be replaced with alternative fasteners (eg. magnet, hook and loop material, adhesive tape, slide, catch or hook) as mechanically preventing face plate removal is no longer a priority.

1. A tamper evident lock assembly, the lock assembly including:
a housing adapted for installation in or on a door;
alterable means in or on the housing adapted for altering the function and/or attributes of the lock assembly; and
a sensor adapted to sense any modification of the lock assembly sufficient to provide access to the alterable means.

2. The lock assembly as claimed in claim 1, wherein the sensor is preferably an electric switch.

3. A tamper evident lock assembly, the lock assembly including:
a housing adapted for installation in or on a door;
alterable means in or on the housing adapted for altering the function and/or attributes of the lock assembly; and
a sensor adapted to sense any modification of the lock assembly altering the alterable means.

4. The lock assembly as claimed in claim 3, wherein the sensor is preferably an electric switch.

5. The lock assembly as claimed in claim 3, wherein the sensor senses a change in a signal from the alterable means caused by the modification.

6. The lock assembly as claimed in claim 3, wherein the sensor senses a change in a signal from a device associated with the alterable means caused by the modification.

7. A tamper evident lock assembly, the lock assembly including:
a housing adapted for installation in or on a door;
alterable means in or on the housing adapted for altering the function and/or attributes of the lock assembly; and
a sensor adapted to sense any approach to, the lock assembly, when installed, for altering the alterable means.

8. The lock assembly as claimed in claim 7, wherein the sensor is a light beam sensor or a proximity sensor.

9. The lock assembly as claimed in claim 8, wherein the light beam or the proximity sensor is positioned outwardly adjacent the alterable means.

10. The lock assembly as claimed in claim 7, wherein the alterable means is any movable part of the lock assembly.

11. The lock assembly as claimed in claim 7, wherein the alterable means is electrically operable.

12. The lock assembly as claimed in claim 11, wherein the alterable means is a switch.

13. The lock assembly as claimed in claim 7, wherein the alterable means is mechanically operable.

14. The lock assembly as claimed in claim 13, wherein the alterable means is a button, knob, screw, lever, toggle, linkage or cam.

15. The lock assembly as claimed in claim 7, wherein the alterable means are preferably accessible without removing the installed lock from the door.

16. The lock assembly as claimed in claim 7, further including a face plate releasably mountable to the housing and a sensor responsive to interference with the face plate, or a part associated with the face plate.

17. The lock assembly as claimed in claim 16, wherein the part associated with the face plate includes: a fastener for fastening the face plate to the housing; a sub face plate connectable to the face plate; or a patch, button or blanking plug mountable in an opening in the face plate.

18. The lock assembly as claimed in claim 17, wherein the fastener is one or more of a screw, bolt, magnet, hook and loop material, adhesive tape, slide, catch or hook.

19. The lock assembly as claimed in claim 16, wherein the interference with the face plate, or a part associated with the face plate, preferably includes:
mounting the face plate, or the part associated with the face plate, on the housing;
removing the face plate, or the part associated with the face plate, from the housing;
removing the face plate, or the part associated with the face plate, from the housing and remounting the face plate, or the part associated with the face plate, to the housing; or
remounting the face plate, or the part associated with the face plate, to the housing.

20. The lock assembly as claimed in claim 16, wherein the sensor is adapted to issue a signal, or cease issuing a signal, when:
the face plate, or the part associated with the face plate, is installed on the housing;
the face plate, or the part associated with the face plate, is mounted to the housing;
the face plate, or the part associated with the face plate, is not mounted to the housing; or
when the face plate, or the part associated with the face plate, is remounted to the housing after removal from the housing.

21. The lock assembly as claimed in claim 7, wherein the housing is installed within a recess in the door.

22. The lock assembly as claimed in claim 7, wherein the housing is installed on an outer face of the door.

23. The lock assembly as claimed in claim 7, wherein the sensor is preferably mechanical, photoelectric, inductive or any of a variety of sensor types.

24. The lock assembly as claimed in claim 7, wherein the sensor directly senses the physical presence of the faceplate or the part associated with the face plate.

25. The lock assembly as claimed in claim 7, wherein the sensor indirectly senses the physical presence of the faceplate, or the part associated with the face plate, via an intermediate mechanism.

26. The lock assembly as claimed in claim 25, wherein the intermediate mechanism is one or more linkages or a magnet.

27. The lock assembly as claimed in claim 25, wherein the intermediate mechanism is attached to the face plate.

28. The lock assembly as claimed in claim 7, wherein the signal triggers a remote alarm or other indication of the tampering.

29. The lock assembly as claimed in claim 28, wherein the remote alarm or indication is momentary, only showing while the face plate or the part associated with the face plate is mounted/not mounted/remounted.

30. The lock assembly as claimed in claim 28, wherein the remote alarm or indication is latching, remaining until an authorised reset.

31. The lock assembly as claimed in claim 30, wherein the authorised reset is preferably a remote signal.

32. The lock assembly as claimed in claim 31, wherein the remote signal is given from a control centre or other such as: an RF signal, an emf signal, an electric signal that can be communicated: through the ether, through a wire forming part of an existing circuit to the lock assembly, through a purpose fitted wire specifically for resetting purposes.

33. The lock assembly as claimed in claim 30, wherein the authorised reset is a local signal.

34. The lock assembly as claimed in claim 32, wherein the lock signal is given from a person in close proximity to the lock such as: an RF signal; an emf signal; an infra red signal; a sound signal; an electric signal; an influence from a proximity fob or a mechanical key, all providing an authorised communication with the lock assembly to provide a reset influence to some mechanical or electrically responding item.

35. The lock assembly as claimed in claim 31, wherein any and all of the above signals, local or remote, may: either reset the lock assembly, and/or reset the alarm state, and/or allow remounting of the faceplate.

36. The lock assembly as claimed in claim 31, wherein the signal does not trigger a remote alarm or other indication and triggers an internal lock change, such as locking the lock assembly and/or some other local alarm or tamper indicator on or near the lock until an authorised reset.

37. The lock assembly as claimed in claim 31, wherein the signal triggers a remote alarm or other remote indicator and/or an internal lock change, such as locking the lock assembly and/or a local alarm or tamper indicator on or near the lock until an authorised reset.

38. A tamper evident lock assembly, the lock assembly including:
a housing adapted for installing in or on a door;
alterable means in or on the housing adapted for altering the function and/or attributes of the lock assembly; and
a lock assembly disabling mechanism adapted to prevent operation of the lock assembly in response to any modification of the lock assembly sufficient to provide access to the alterable means and/or in response to any altering of the alterable means.

39. The lock assembly as claimed in claim 38, wherein the lock assembly includes a face plate releasably mountable to the housing and the lock assembly disabling mechanism is adapted to allow authorised operation of the lock assembly in response to authorised mounting of the face plate and to prevent operation of the lock assembly in response to interference with the face plate, or a part associated with the face plate.

40. The lock assembly as claimed in claim 39, wherein the interference with the face plate, or a part associated with the face plate, includes:
mounting the face plate, or the part associated with the face plate, on the housing;
removing the face plate, or a part associated with the face plate;
removing the face plate, or a part associated with the face plate, from the housing and remounting the face plate, or a part associated with the face plate, to the housing; or
remounting the face plate, or a part associated with the face plate, to the housing.

41. The lock assembly as claimed in claim 38, wherein the lock assembly disabling mechanism is adapted to continue to prevent operation of the lock assembly after unauthorised remounting of the face plate or the part associated with the face plate and/or prevents the faceplate from being remounted.

42. The lock assembly as claimed in claim 38, wherein the housing is installed within a recess in the door.

43. The lock assembly as claimed in claim 38, wherein the housing is installed on an outer face of the door.

44. The lock assembly as claimed in claim 38, wherein the lock assembly disabling mechanism includes:
a bolt blocking means movable between a first position allowing authorised operation of a lock bolt and a second position preventing operation of the lock bolt; and
means biasing the bolt blocking means towards the second position,
wherein the authorised mounting of the face plate, or the part associated with the face plate, to the housing permits moving of the bolt blocking means to the first position and removing the face plate, or the part associated with the face plate, from the housing allows the biasing means to move the bolt blocking means to the second position.

45. The lock assembly as claimed in claim 38, wherein any combination of mechanical and electrical tamper sensing and signalling is possible within a single lock.

46. The lock assembly as claimed in claim 45, wherein an electrical tamper signal can also be used to trigger a mechanical operation within the lock.

47. The lock assembly as claimed in claim 40, wherein the part associated with the face plate includes: a fastener for fastening the face plate to the housing; a sub face plate connectable to the face plate; or a patch, button or blanking plug mountable in an opening in the face plate.

48. The lock assembly as claimed in claim 48, wherein the fastener is one or more of a screw, bolt, magnet, hook and loop material, adhesive tape, slide, catch or hook.
